(19) United States
(12) Patent Application Publication
(10) Pub. No.: US 2010/0185880 A1
(43) Pub. Date: Jul. 22, 2010

(54) TEST APPARATUS

(75) Inventors: CHIA-SHIN CHOU, Tu-Cheng (TW); ZHEN-XING YE, Shenzhen City (CN); XIAO-ZHU CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/412,386

(22) Filed: Mar. 27, 2009

(30) Foreign Application Priority Data
Jan. 16, 2009 (CN) 200910300226.2

(51) Int. Cl. G06F 1/00

(52) U.S. Cl. 713/300

(57) ABSTRACT

A test apparatus for supporting compatibility testing between a motherboard and a number of power supply units includes a plug, a number of sockets, and a microprocessor. The plug is configured for connecting to the motherboard. The number of sockets is configured for connecting to the number of power supply units. The microprocessor is connected to the plug and the number of sockets, and is capable of turning on or turning off the number of power supply units, according to a power supply on signal received from the motherboard.

### BACKGROUND

1. Technical Field

The present disclosure relates to test apparatuses, and particularly to a test apparatus supporting compatibility testing between a motherboard and a plurality of power supply units.

2. Description of Related Art

Compatibility of a power supply unit supplying power for a motherboard is one of the important indexes used to measure performance of an electronic device, such as a desktop computer, a notebook computer, or a server. To ensure the motherboard has a high compatibility, a plurality of power supply units are employed, and are tested by testing software, such as 3DMark, installed in the motherboard. That is, the motherboard is tested for a plurality of times via the plurality of power supply units and the testing software.

During testing, only one of the power supply unit can be employed at each time to implement the test, and the power supply unit is electrically connected to the motherboard to supply power to the motherboard. However, when a plurality of power supply units are employed to implement the test, the repeated connecting/disconnecting of each power supply to the motherboard is time consuming, and may cause imprecise test results.

### BRIEF DESCRIPTION OF THE DRAWINGS

FIG. 1 is a schematic diagram of an embodiment of a test apparatus.

FIG. 2 is a circuit diagram of an embodiment of the test apparatus supporting compatibility testing between a motherboard and first and second power supply units.

FIG. 3 is a schematic diagram of an embodiment of the test apparatus supporting compatibility testing between the motherboard and the first and second power supply units.

### DETAILED DESCRIPTION

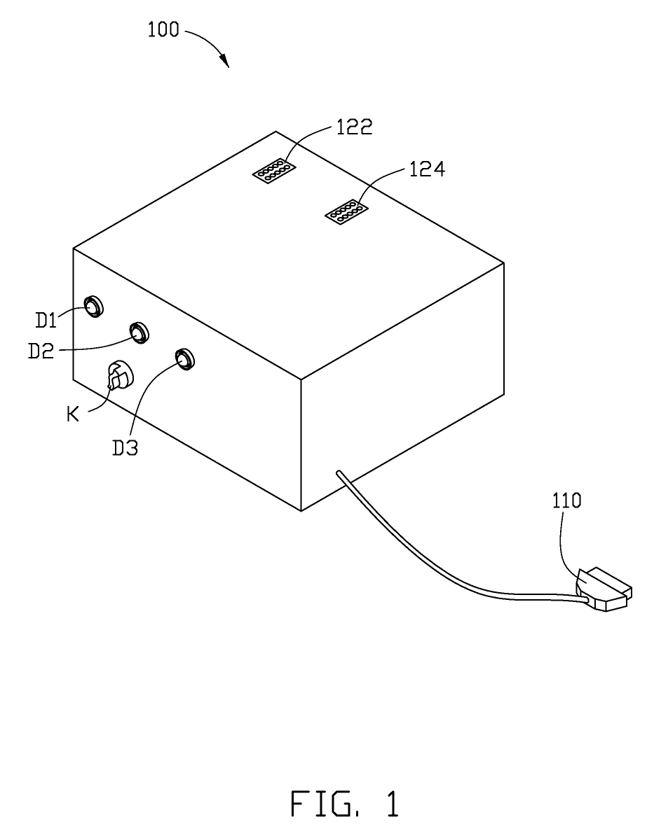

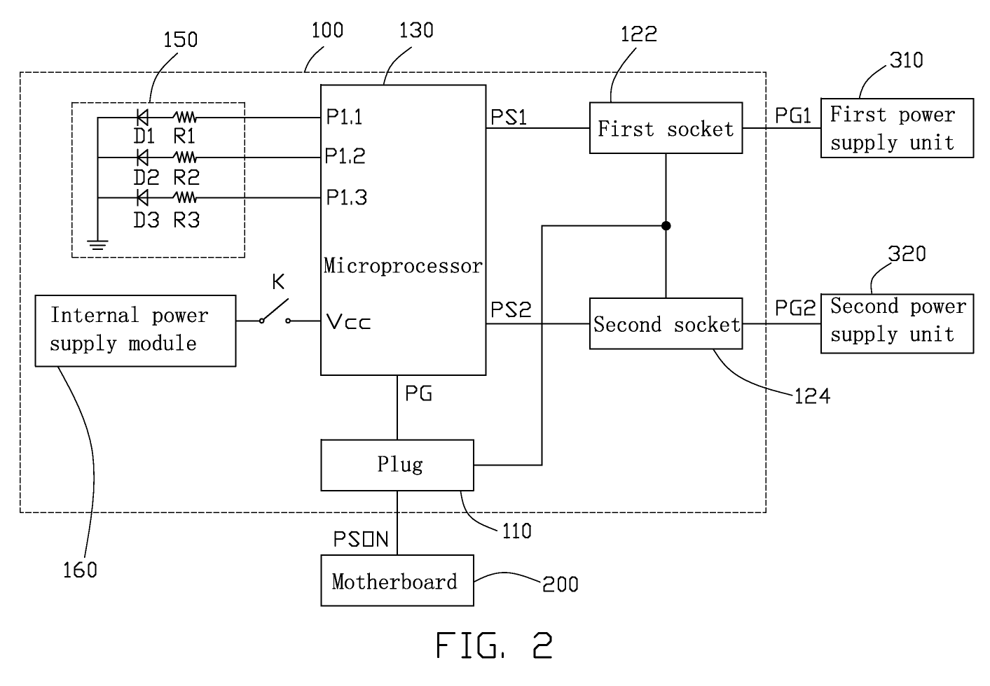

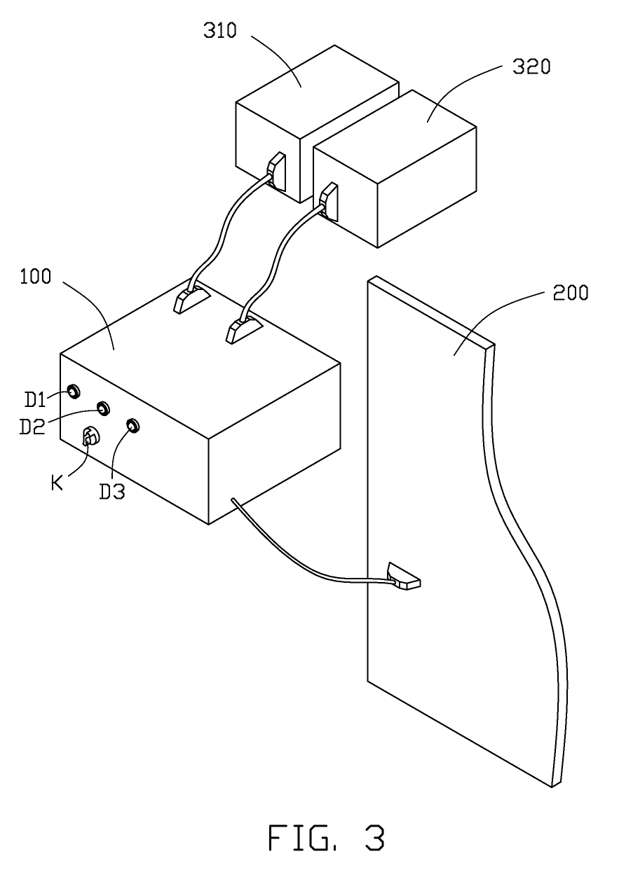

Referring to FIG. 1 to FIG. 3, an exemplary embodiment of a test apparatus 100 includes a plug 110, a first socket 122, a second socket 124, a microprocessor 130, a display unit 150, and an internal power supply module 160. The plug 110 is configured for connecting to a motherboard 200. The first socket 122 is configured for connecting to a first power supply unit 310. The second socket 124 is configured for connecting to a second power supply unit 320. The microprocessor 130 stores a plurality of predetermined programs, to turn on and turn off the first power supply unit 310 and the second power supply unit 320, according to signals received from the motherboard 200. The display unit 150 is configured for indicating whether the first power supply unit 310, the second power supply unit 320, and the microprocessor 130 are functioning normally. The internal power supply module 160 is connected to the microprocessor 130 via a switch K, to supply power for the microprocessor 130. In one embodiment, the first power supply unit 310 and the second supply unit 320 have similar structures and are configured for transforming an external power source to a variety of voltage signals needed by the motherboard 200. The motherboard 200 is installed with a plurality of software, including testing software, such as 3DMark, to test compatibility of the motherboard 200 with a power supply unit supplying power to the motherboard 200. In other embodiments, the number of power supply units can be varied according to actual need, and the number of the sockets on the test apparatus 100 can be varied correspondingly.

The first power supply unit 310 is connected to the microprocessor 130 via the first socket 122, the second supply unit 320 is connected to the microprocessor 130 via the second socket 124, and the motherboard 200 is connected to the microprocessor 130 via the plug 110. As a result, the first power supply unit 310, the second supply unit 320, and the motherboard 200 can communicate with the microprocessor 130. The first socket 122 and the second socket 124 are connected to the plug 110, thereby, voltage signals, such as a 5V standby voltage 5V SB, a 5V system voltage 5V SYS, a 3.3V system voltage 3.3V SYS, and a 12V system voltage 12V SYS, outputted by the first power supply unit 310 or the second supply unit 320 may be transmitted to the motherboard 200.

In one embodiment, the display unit 150 includes three light-emitting elements, such as, three light-emitting diodes (LEDs) D1, D2, D3. An anode of the LED D1 is connected to an output pin P1.1 of the microprocessor 130 via a resistor R1, an anode of the LED D2 is connected to an output pin P1.2 of the microprocessor 130 via a resistor R2, an anode of the LED D3 is connected to an output pin P1.3 of the microprocessor 130 via a resistor R3, and cathodes of the LEDs D1, D2, D3 are grounded. The switch K is configured for turning on or turning off the test apparatus 100, including a first terminal connected to a power pin Vcc of the microprocessor 130, and a second terminal connected to the internal power supply module 160. In other embodiments, the number of the LEDs can be varied corresponding with the number of the sockets.

In test, the switch K is closed after the plug 110 is connected to the motherboard 200, a plug of the first power supply unit 310 is inserted into the first socket 122, and a plug of the second power supply unit 320 is inserted into the second socket 124. The internal power supply module 160 supplies power to the microprocessor 130, and the LED D1 indicates whether the microprocessor 130 is functioning normally, that is, if the LED D1 lights up, the microprocessor 130 is functioning normally, otherwise, the microprocessor 130 is abnormal, and needs to be replaced or repaired.

A power-on button of the motherboard 200 is pressed down when the LED D1 lights up, and a power supply on signal PSON is transmitted to the microprocessor 130 from the motherboard 200. The microprocessor 130 outputs a control signal PS1 at a low level (e.g., a logical zero) to turn on the first power supply unit 310, after receiving the signal PSON. Accordingly, the first power supply unit 310 transmits a feedback signal PG1 to the microprocessor 130, and provides a variety of voltage signals to the motherboard 200. The microprocessor 130 outputs a power good signal PG to the motherboard 200 after receiving the signal PG1, and controls the pin P1.2 to output a signal at a high level (e.g., 5V) to turn on the LED D2. The LED D2 lights up and indicates that the first power supply unit 310 is functioning normally. The motherboard 200 enters into a boot state, after receiving the signal PG, and automatically runs corresponding testing software, such as 3DMark, to test whether the motherboard 200 is compatible with the first power supply unit 310.

The motherboard 200 automatically restarts after testing the first power supply unit 310 finishes, and outputs the signal PSON to the microprocessor 130 again. The microprocessor 130 outputs the signal PS1 at a high level (e.g., a logical one) to turn off the first power supply unit 310, and a control signal PS2 at a low level to turn on the second power supply unit 320. The second power supply unit 320 transmits a feedback signal PG2 to the microprocessor 130, and provides a variety of voltage signals to the motherboard 200. The microprocessor 130 outputs the signal PG to the motherboard 200 after receiving the signal PG2, and controls the pin P1.3 to output a signal at a high level (e.g., 5V) to turn on the LED D3. The LED D3 lights up and indicates the second power supply unit 320 is functioning normally. The motherboard 200 enters into the boot state again, after receiving the signal PG, and automatically runs the corresponding test software to test whether the motherboard 200 is compatible with the second power supply unit 320.

Likewise, the test apparatus 100 is capable of supporting the motherboard 200 to automatically and orderly test whether a plurality of power supply units are compatible with the motherboard 200, via arranging a plurality of sockets on the test apparatus 100 to connect the plurality of power supply units. Therefore, manpower and time are saved, and testing efficiency is improved. Furthermore, working states of the microprocessor 130 and the plurality of power supply units can be indicated/monitored by corresponding LEDs of the display unit 150. Therefore, test errors caused by abnormal of the microprocessor 130 and the plurality of power supply units can be avoid, and the result of the test is more precise.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A test apparatus for supporting compatibility testing between a motherboard and a plurality of power supply units, the test apparatus comprising:
a plug to connect to the motherboard;
a plurality of sockets to connect the plurality of power supply units, wherein the plurality of sockets are connected to the plug to transmit a plurality of voltage signals output by each of the plurality of power supply units to the motherboard; and
a microprocessor connected to the plug and the plurality of sockets, and capable of turning on or turning off the plurality of power supply units, according to a power supply on signal received from the motherboard;
wherein the microprocessor outputs a first control signal at a low level to turn on one of the plurality of power supply units, in response to receiving the power supply on signal; the power supply unit transmits a feedback signal to the microprocessor, and provides the plurality of voltage signals to the motherboard, upon the condition that the power supply unit works normally; and wherein the motherboard tests the power supply unit in response to receiving a power good signal from the microprocessor; and
wherein the motherboard restarts in response to when testing of the power supply unit finishes, and outputs the power supply on signal to the microprocessor again; the microprocessor outputs a second control signal at a high level to turn off the power supply unit, and a third control signal at a low level to turn on a next power supply unit, to enable the motherboard to test the next power supply unit.

2. The test apparatus of claim 1, further comprising a display unit connected to the microprocessor, wherein the display unit includes a plurality of light-emitting elements configured for indicating whether the microprocessor and the plurality of power supply units work normally.

3. The test apparatus of claim 2, wherein the plurality of light-emitting elements are a plurality of light-emitting diodes (LEDs), an anode of each of the plurality of LEDs is connected to a corresponding output pin of the microprocessor via a resistor, and cathodes of the plurality of LEDs are grounded.

4. The test apparatus of claim 1, further comprising an internal power supply module connected to the microprocessor via a switch, wherein the internal power supply module supplies power for the microprocessor, and the switch is capable of turning on or off the test apparatus.
